(19) United States
(12) Patent Application Publication
(10) Pub. No.: US 2021/0400411 A1
(43) Pub. Date: Dec. 23, 2021

(54) AUDIO OUTPUT APPARATUS FOR WIRELESSLY RECEIVING DATA FROM ELECTRONIC DEVICE AND METHOD OF OPERATING THE SAME

(71) Applicant: Samsung Electronics Co., Ltd., Gyeonggi-do (KR)

(72) Inventors: Mingyu LEE, Gyeonggi-do (KR); Taeyoung Ha, Gyeonggi-do (KR)

(73) Assignee: Samsung Electronics Co., Ltd.

(21) Appl. No.: 17/350,604

(22) Filed: Jun. 17, 2021

(30) Foreign Application Priority Data
Jun. 19, 2020 (KR) 10-2020-0075030

(51) Int. Cl. H04S 1/00; H04R 5/033; H04L 29/06; H04L 12/801; H04W 56/00; H04W 4/80

(52) U.S. Cl. CPC H04S 1/007; H04R 5/033; H04L 65/60; H04R 2420/07; H04W 56/001; H04W 4/80; H04L 47/14

(57) ABSTRACT

A first audio output apparatus and method performed by the first audio output apparatus are provided to wirelessly receive data from an electronic device. The method includes receiving a first media packet transmitted from the electronic device through a first frequency channel; determining to maintain the first frequency channel based on the first media packet and a second media packet received before the first media packet; transmitting, to a second audio output apparatus, a stay packet indicating to maintain the first frequency channel; and receiving a third media packet from the second audio output apparatus through the first frequency channel.

### CROSS-REFERENCE TO RELATED APPLICATION

This application is based on and claims priority under 35 U.S.C. § 119 to Korean Patent Application No. 10-2020-0075030, filed on Jun. 19, 2020, in the Korean Intellectual Property Office, the entire disclosure of which is incorporated herein by reference.

### BACKGROUND

### 1. Field

The disclosure relates generally to an audio output apparatus configured to wirelessly receive data from an electronic device and output audio, and a method of operating the audio output apparatus.

### 2. Description of the Related Art

When users view content through personalized electronic devices, such as smart phones and tablet personal computers (PCs), wireless earphones are often preferred over wired earphones. In particular, Bluetooth®, which is a near field wireless communication technology, for exchanging information by connecting portable devices, such as mobile phones, notebooks, earphones, headphones, etc., to each other, is widely used. However, near field wireless communication technologies, such as Bluetooth®, are mainly used for a low power wireless connection within a very short range of about 10 meters.

There is also a demand, with respect to a plurality of wireless audio output apparatuses configured to wirelessly receive data and output an audio signal, for a method of operating an audio output apparatus in which an audio signal is synchronized with a plurality of wireless audio output apparatuses and output, while minimizing power consumption.

### SUMMARY

The disclosure has been made to address the above-mentioned problems and disadvantages, and to provide at least the advantages described below.

According to an aspect of the disclosure, a method is provided for a first audio output apparatus. The method includes receiving a first media packet transmitted from an electronic device through a first frequency channel, determining to maintain the first frequency channel, based on the first media packet and a second media packet received before the first media packet, transmitting, to a second audio output apparatus, a stay packet indicating to maintain the first frequency channel, and receiving a third media packet from the second audio output apparatus through the first frequency channel.

The method may further comprises overhearing a data exchange between the electronic device and the second audio output apparatus.

The determining to maintain the first frequency channel may include determining whether a reception of at least one media packet has failed, based on a first index of the first media packet and a second index of the second media packet, and based on determining that the reception of the at least one media packet has failed, generating the stay packet including the second index of the second media packet.

The first audio output apparatus and the second audio output apparatus may form a pair of wireless earphones, the second audio output apparatus may include a primary device configured to perform a data exchange with the electronic device, and the first audio output apparatus may include a secondary device configured to overhear a data exchange between the electronic device and the second audio output apparatus.

The method may further include transmitting, to the second audio output apparatus, a synchronization request packet for performing synchronization.

The method may further include transmitting, to the second audio output apparatus through a second frequency channel, a synchronization request packet including an index of a media packet recently received, receiving a synchronization response packet from the second audio output apparatus through the second frequency channel, determining to maintain the second frequency channel based on the synchronization response packet, receiving a fourth media packet from the second audio output apparatus through the second frequency channel, and transmitting, to the second audio output apparatus, a reception acknowledgement response regarding the fourth media packet.

The method may further include transmitting, to the second audio output apparatus through a second frequency channel, a synchronization request packet, the synchronization request packet including an index of a media packet recently received, when a synchronization response packet is not received from the second audio output apparatus through the second frequency channel, transmitting the synchronization request packet to the second audio output apparatus through a third frequency channel, receiving a synchronization response packet from the second audio output apparatus through the third frequency channel, determining to maintain the third frequency channel based on the synchronization response packet, receiving a fourth media packet from the second audio output apparatus through the third frequency channel, and transmitting, to the second audio output apparatus, a reception acknowledgement response regarding the fourth media packet.

The electronic device, the first audio output apparatus, and the second audio output apparatus may perform communication by using a Bluetooth communication scheme.

The method may further include transmitting, to the second audio output apparatus, a reception acknowledgement response regarding the third media packet.

According to another aspect of the disclosure, a method is provided for a second audio output apparatus. The method includes receiving a first media packet transmitted from an electronic device through a first frequency channel, receiving, from a first audio output apparatus, a stay packet indicating to maintain the first frequency channel, and based on a first index of the first media packet and a second index included in the stay packet, transmitting a second media packet to the first audio output apparatus through the first frequency channel.

According to another aspect of the disclosure, a first audio output apparatus is provided. The first audio output apparatus includes a communicator configured to receive a media packet from an electronic device, and a processor configured to receive a first media packet transmitted from the electronic device through a first frequency channel, determine to maintain the first frequency channel, based on the first media packet and a second media packet received before the first media packet, transmit, to a second audio output apparatus, a stay packet indicating to maintain the first frequency channel, and receive a third media packet from the second audio output apparatus through the first audio output apparatus.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a general device-to-device (D2D) communication procedure;

FIG. 2 illustrates a communication process of a plurality of electronic devices;

FIG. 3 illustrates a Bluetooth® protocol for transmitting or receiving data between electronic devices;

FIG. 4 illustrates a media packet transmitted through Bluetooth®;

FIG. 5 illustrates information elements of a media packet;

FIG. 6 illustrates audio output apparatuses receiving data from an electronic device, according to an embodiment;

FIG. 7 is a flowchart illustrating a method performed by a first audio output apparatus, according to an embodiment;

FIG. 8 is a flowchart illustrating a method performed by a second audio output apparatus, according to an embodiment;

FIG. 9 illustrates a first audio output apparatus transmitting a stay packet to a second audio output apparatus, according to an embodiment;

FIG. 10 illustrates a first audio output apparatus transmitting a synchronization packet to a second audio output apparatus, according to an embodiment;

FIG. 11 illustrates a first audio output apparatus transmitting a synchronization packet to a second audio output apparatus, according to an embodiment;

FIG. 12A illustrates a first audio output apparatus transmitting a synchronization packet to a second audio output apparatus, according to an embodiment;

FIG. 12B illustrates a first audio output apparatus transmitting a synchronization packet to a second audio output apparatus, according to an embodiment;

FIG. 13 illustrates a first audio output apparatus and a second audio output apparatus suspending a Bluetooth® low energy (BLE) transfer time, according to an embodiment;

FIG. 14 illustrates a first audio output apparatus according to an embodiment;

FIG. 15 illustrates a second audio output apparatus according to an embodiment; and

FIG. 16 illustrates an electronic device according to an embodiment.

### DETAILED DESCRIPTION

Various embodiments of the disclosure will be described hereinafter with reference to the accompanying drawings so that they may be easily implemented by those of ordinary skill in the art. However, embodiments of the disclosure may have different forms and should not be construed as being limited to the embodiments set forth herein. In addition, descriptions not related to embodiments of the disclosure will be omitted to clearly explain the embodiments thereof in the drawing. Like reference numerals may denote like elements throughout.

The terms used herein are selected as common terms widely used now, taking into account principles of the disclosure, which may depend on intentions of those of ordinary skill in the art, judicial precedents, emergence of new technologies, etc. Therefore, terms used in the disclosure should not be interpreted only by the name of the term, but should be interpreted based on the meaning of the term and the content throughout the disclosure.

Although numerical terms such as “first”, “second”, etc., may be used herein to describe various elements or components, these elements or components should not be limited by these terms. The numerical terms may be used only to distinguish one component from another component.

The terminology as used herein is only used for describing particular embodiments of the disclosure and not intended to limit the disclosure.

An expression used in the singular encompasses an expression of the plural unless the context expressly indicates otherwise.

When an element A is expressed to “be connected” to element B, this may indicate that element A is “directly connected” to element B or “electrically connected” to element B with an element C located between elements A and B.

The term “include (or including)” or “comprise (or comprising)” is inclusive or open-ended and does not exclude additional, unrecited elements or method steps, unless otherwise mentioned.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, etc.

In the disclosure, a controller may also be referred to as a processor, and a layer (or a layer apparatus) may also be referred to as an entity.

Operations for describing a method according to the disclosure may be performed in a suitable order unless the context clearly dictates otherwise. The disclosure is not, however, limited to the described order of the operations.

Expressions such as “in an embodiment of the disclosure” or similar expressions used throughout the specification are not intended to indicate the same embodiment.

An embodiment of the disclosure may be described in terms of functional block elements and various processing operations. Some or all of the functional blocks may be implemented by any number of hardware and/or software components configured to perform the specified functions. For example, the functional blocks may be implemented by one or more microprocessors or circuit elements having dedicated functions. Further, functional blocks may be implemented in various programming or scripting languages. Functional blocks may be implemented in algorithms executed on one or more processors. Moreover, the disclosure may employ any number of general techniques for electronic configuration, signal processing, and/or data processing.

Connecting lines or members between the elements illustrated in the accompanying drawings are illustratively shown as functional and/or physical connections or circuit connections. In practice, functional, physical, or circuit connections that may be replaced or added may be employed between the elements.

In general, wireless sensor network technology may be classified into a wireless local area network (WLAN) and a wireless personal area network (WPAN) according to a distance identified. WLAN is an IEEE 802.11-based technology for connection to a backbone network within a radius of about 100 m. WPAN is a technology based on IEEE 802.15, and examples thereof include Bluetooth®, ZigBee®, ultra-wide band (UWB), etc.

A wireless network in which such wireless network technology is implemented may include a plurality of communication electronic devices. In this case, the plurality of communication electronic devices establish communication in an active period by using a single channel. That is, the plurality of communication electronic devices may collect and transmit packets in the active period.

Electronic devices according to embodiments may include a fixed UE embodied as a computer device or a mobile UE, and communicate with other devices and/or servers by using a wireless or wired communication method. For example, the electronic devices may include, but are not limited to, smart phones, mobile terminals, laptop computers, digital broadcasting terminals, personal digital assistants (PDAs), portable multimedia players (PMPs), navigation devices, or slate PCs, tablet PCs, desktop computers, digital televisions (TVs), refrigerators, wearable devices, projectors, earphones, speakers, smart keys, smart cars, printers, etc.

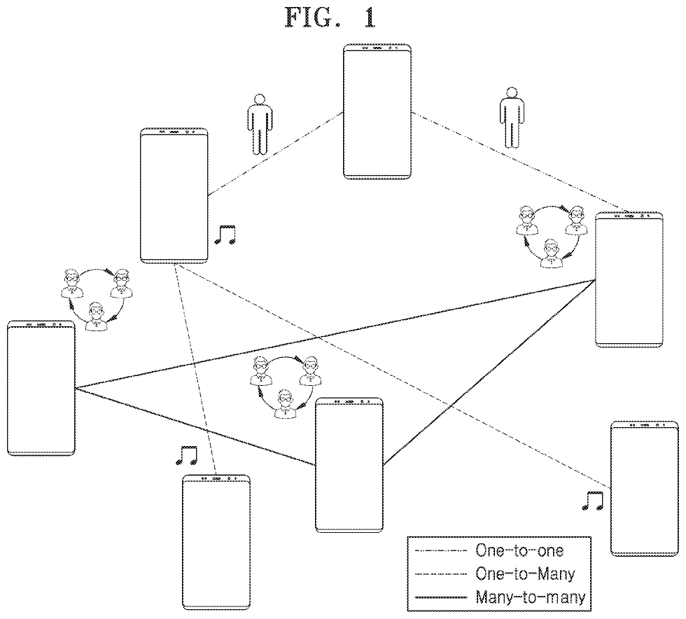

FIG. 1 illustrates a general D2D communication procedure.

Referring to FIG. 1, D2D communication refers to an operation in which geographically adjacent electronic devices communicate directly with each other, without using an intermediary infrastructure element such as a base station. The electronic devices may communicate in a one-to-one manner, a one-to-many manner, or a many-to-many manner. In D2D communication, unlicensed frequency bands such as Wi-Fi Direct® and Bluetooth® may be used. Alternatively, in D2D communication, licensed frequency bands may be used to improve frequency utilization efficiency of cellular systems. Although D2D communication is restrictively used to refer to machine-to-machine (M2M) communication or machine intelligent communication, in the disclosure, D2D communication is intended to refer to communication between electronic devices having a communication function and also communication between various types of electronic devices having a communication function, such as smart phones or PCs.

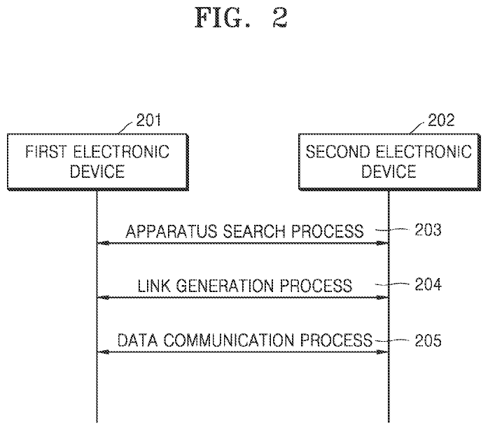

FIG. 2 illustrates a communication process of a plurality of electronic devices.

Referring to FIG. 2, a first electronic device 201 and a second electronic device 202 perform D2D communication through an apparatus search process 203, a link generation process 204, and a data communication process 205.

In the apparatus search process 203, each of the first electronic device 201 and the second electronic device 202 search for other electronic devices capable of performing D2D communication among electronic devices around the first electronic device 201 and the second electronic device 202. Accordingly, each of the first electronic device 201 and the second electronic device 202 may determine whether a link for performing D2D communication is generated. The first electronic device 201 may transmit a search signal to allow the second electronic device 202 to search for the first electronic device 201. The first electronic device 201 may receive the search signal from the second electronic device 202 and identify that other electronic devices capable of performing D2D communication are within a D2D communication range.

In the link generation process 204, each of the first electronic device 201 and the second electronic device 202 generate a link for transmitting data to an electronic device, to which the data is to be transmitted, from among the electronic devices found in the apparatus search process 203. The first electronic device 201 may generate a link for transmitting data to the second electronic device 202 found in the apparatus search process 203.

In the data communication process 205, each of the first electronic device 201 and the second electronic device 202 transmits or receives data to or from apparatuses that generate a link in the link generation process 204. The first electronic device 201 may transmit or receive data to or from the second electronic device 202 through the link generated in the link generation process 204.

Various embodiments relate to data transmission or reception based on D2D communication, and more particularly, to a method of stably transferring a media packet by using a Bluetooth® communication scheme.

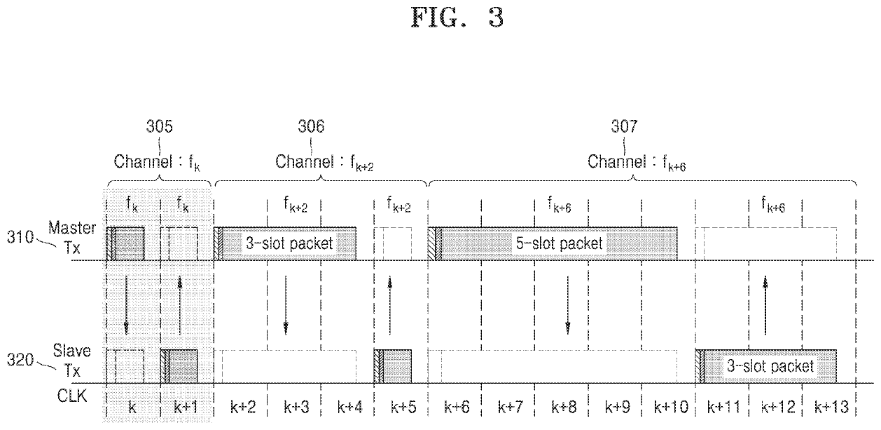

FIG. 3 illustrates a Bluetooth® protocol for transmitting or receiving data between electronic devices.

According to the Bluetooth® communication scheme, electronic devices may operate in units of time slots.

In a Bluetooth® network, a master/slave model may be used to control a time at which data is transmitted and a device used to transmit data. One master device may be connected to a plurality of slave devices, but one slave device may only be connected to one master device.

A device configured to provide a synchronization reference among two or more electronic devices configured to perform Bluetooth® communication may be referred to as a master device. Among the two or more electronic devices configured to perform Bluetooth® communication, another device that is synchronized with a clock and a frequency hopping pattern of the master device may be referred to as a slave device.

Electronic devices supporting Bluetooth® communication may use adaptive frequency hopping (AFH) in which hopping is performed according to a pseudo-random hopping sequence in order to minimize the interference by other devices. However, in a master-slave data transmission or reception, a same channel mechanism may be used by which transmission of data and a response reception of the corresponding data are performed on the same channel.

Referring to FIG. 3, a master 310 and a slave 320, which are configured to communicate with each other through Bluetooth®, may perform communication by hopping a frequency channel from a first channel fₖ 305 to a second channel fₖ₊₂ 306 and from the second channel fₖ₊₂ 306 to a third channel fₖ₊₆ 307.

In a time slot k, the master 310 may transmit data to the slave 320 through the first channel fₖ 305, and in a next time slot k+1, the slave 320 may transmit data, e.g., an acknowledgement (ACK) or a negative acknowledgement (NACK), to the master 310 through the same first channel fₖ 305.

When the slave 320 fails to detect the data transmission by the master 310 in the time slot k, the slave 320 may perform a frequency channel hopping to fₖ₊₁ in the next time slot k+1. The master 310 transmitting the data in the time slot k may maintain the first channel fₖ 305 in order to receive a response of the slave 320 in the next time slot k+1. Therefore, frequency channels of the master 310 and the slave 320 may be different from each other in the time slot k+1. However, the master 310 and the slave 320 may be synchronized again with each other by performing a frequency channel hopping to the second channel fₖ₊₂ 306 in a time slot k+2.

In the time slot k+2, the master 310 may transmit data to the slave 320 through the second channel fₖ₊₂ 306. In this case, while the data is transmitted to the slave 320 from the master 310, even if a time slot is changed, no frequency channel hopping occurs and the frequency channel is maintained. After the master 310 has transmitted a 3-slot packet, in a subsequent time slot k+5, the slave 320 may transmit data, e.g., an ACK or a NACK, to the master 310 through the same second channel fₖ₊₂ 306.

The master 310 and the slave 320 may perform a frequency channel hopping, and in a time slot k+6, the master 310 may transmit data to the slave 320 through a third channel fₖ₊₆ 307. While the data is transmitted to the slave 320 from the master 310, even if a time slot is changed, no frequency channel hopping occurs and the frequency channel is maintained. After the master 310 has transmitted a 5-slot packet, in a subsequent time slot k+11, the slave 320 may transmit data to the master 310 through the same third channel fₖ₊₆ 307.

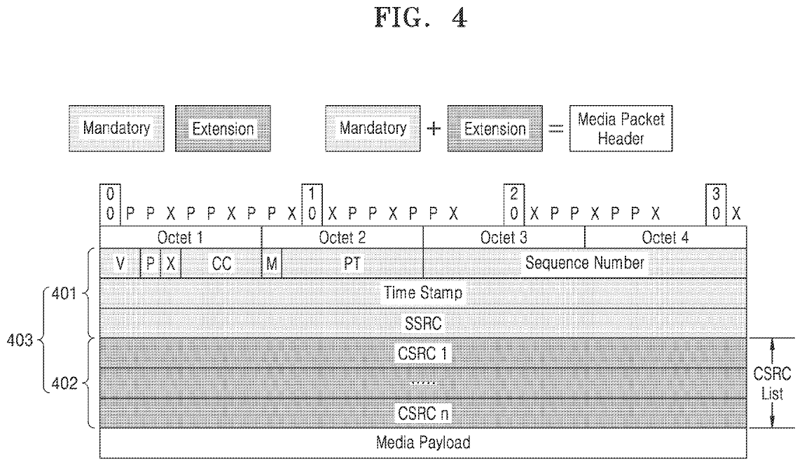

FIG. 4 illustrates a media packet transmitted through Bluetooth®.

Referring to FIG. 4, the media packet includes a media packet header 403 and a media payload. The media packet header 403 includes a mandatory information element 401 that must be included, and an extension information element 402 that may be additionally included. When media data is transmitted, a sequence number may be included as an index for each packet.

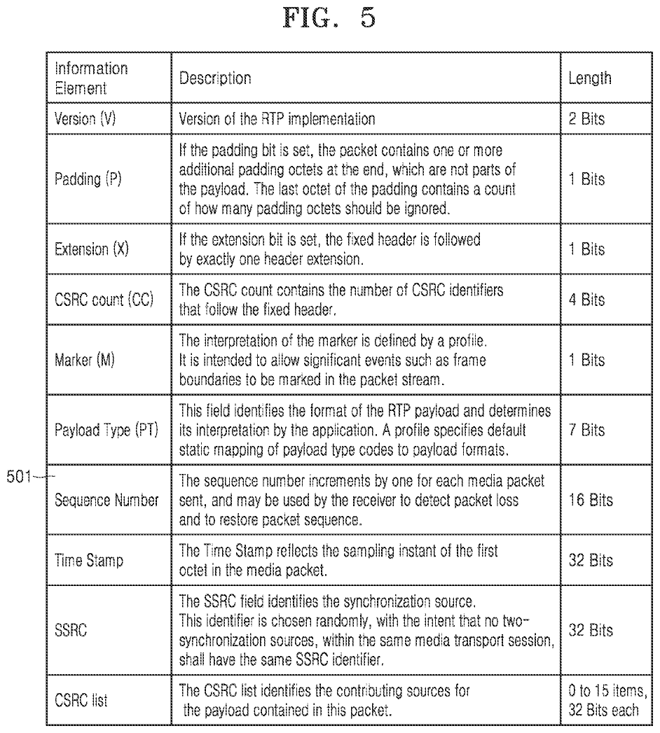

FIG. 5 illustrates information elements of a media packet.

Referring to FIG. 5, a sequence number field 501 included in the media packet header 403 may increment by one for each media packet transmitted. The sequence number field 501 may be used by a receiver to detect packet loss and to restore packet sequence.

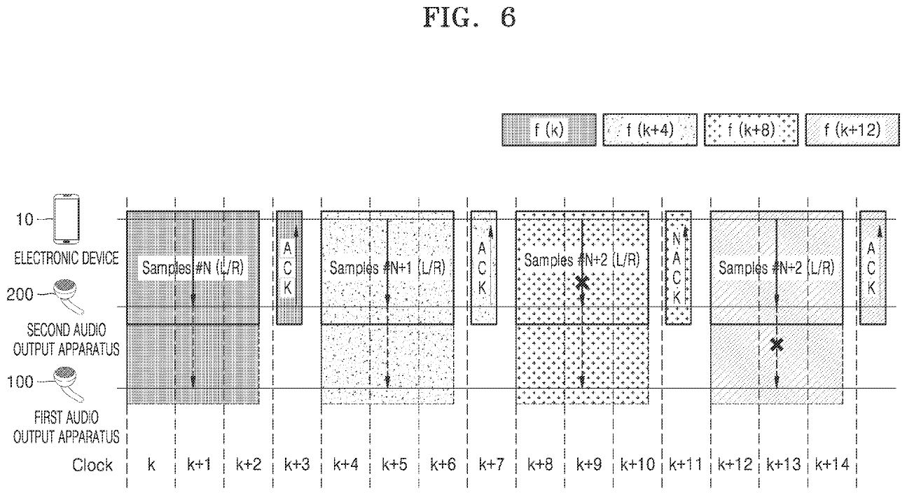

FIG. 6 illustrates a first audio output apparatus and a second audio output apparatus receiving data from an electronic device, according to an embodiment.

Referring to FIG. 6, an electronic device 10 is connected to the first and second audio output apparatuses 100 and 200 through Bluetooth®. In FIG. 6, it is assumed that the electronic device 10 is operated as a master device, and the first and second audio output apparatuses 100 and 200 are operated as slave devices.

The second audio output apparatus 200 may be paired with the electronic device 10 and operated as a primary device configured to directly exchange data. The first audio output apparatus 100 may be operated as a secondary device that is configured to unilaterally receive data from the electronic device 10 without exchanging data with the electronic device 10. The first audio output apparatus 100 may receive data from the electronic device 10 by overhearing a data exchange between the electronic device 10 and the second audio output apparatus 200.

When the second audio output apparatus 200 normally receives data from the electronic device 10, the second audio output apparatus 200 may transmit a reception ACK signal to the electronic device 10, regardless of whether the first audio output apparatus 100 has successfully received data. However, the first audio output apparatus 100 normally receives data from the electronic device 10, or does not perform a separate additional operation even when the data reception fails.

As illustrated in FIG. 6, when the electronic device 10 transmits a sample #N+2 in a time period from a time slot k+8 to a time slot k+10, but the second audio output apparatus 200 fails to normally receive the data from the electronic device 10, the second audio output apparatus 200 may transmit a reception failure (signal, e.g., a NACK signal, to the electronic device 10. The electronic device 10 receiving the NACK signal may retransmit the sample #N+2 during a time period from a time slot k+12 to a time slot k+14. However, the first audio output apparatus 100 does not perform a separate additional operation, even when the first audio output apparatus 100 fails to receive data from the electronic device 10.

When the second audio output apparatus 200 normally receives the sample #N+2, the second audio output apparatus 200 may transmit an ACK signal to the electronic device 10. However, as illustrated in FIG. 6, the first audio output apparatus 100 does not perform a separate additional operation in a next time slot k+15, even when the first audio output apparatus 100 fails to receive the data from the electronic device 10 during a time period from the time slot k+12 to the time slot k+14. The second audio output apparatus 200 may transmit an ACK to the electronic device 10, even when the first audio output apparatus 100 does not normally receive the sample #N+2 during the time period from the time slot k+12 to the time slot k+14.

The second audio output apparatus 200 may request the electronic device 10 to retransmit the data by using an ACK or a NACK. With respect to the first audio output apparatus 100, a process of identifying whether the first audio output apparatus receives the data, and in case of reception failure, re-receiving the data from the electronic device 10 or the second audio output apparatus 200 may be required.

Among a plurality of slaves configured to communicate with a master, various methods are provided herein to restore a reception failure of a secondary device that is not configured to directly communicate with the master.

According to an embodiment, to identify whether the first audio output apparatus 100 has successfully received data from the electronic device 10, a method in which the second audio output apparatus 200 communicates with the first audio output apparatus 100 through BLE may be used. According to the method in which the first audio output apparatus 100 and the second audio output apparatus 200 communicate with each other by using BLE, a mandatory channel transfer from Bluetooth® to BLE occurs every connection interval period.

For example, when a transfer to BLE occurs while data is transmitted to the first audio output apparatus 100 and the second audio output apparatus 200 from the electronic device 10 through Bluetooth®, or when data is transmitted to the second audio output apparatus 200 from the electronic device 100 while the data is exchanged between the first audio output apparatus 100 and the second audio output apparatus 200 through BLE, a data transmission failure may occur. As a result, a delay may increase due to the data transmission failure.

Thus, the first audio output apparatus 100 and the second audio output apparatus 200 may perform communication through Bluetooth®, not BLE, in order to reduce delay according to the increased probability of data transmission failure as a result of a Bluetooth®-BLE transfer.

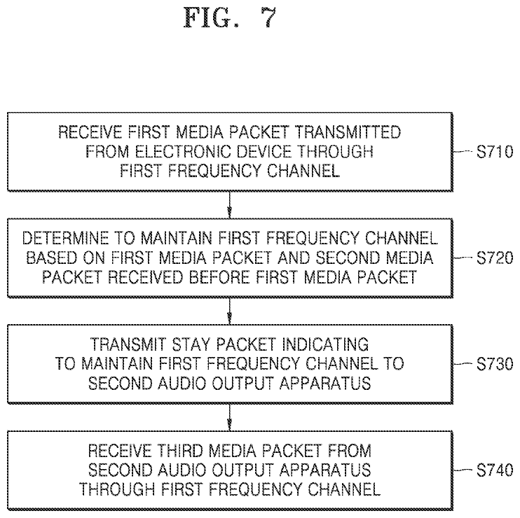

FIG. 7 is a flowchart illustrating a method performed by a first audio output apparatus, according to an embodiment.

Referring to FIG. 7, the first audio output apparatus 100 may be paired with the second audio output apparatus 200 to receive data from the electronic device 10, and output an audio signal obtained from the received data. The first audio output apparatus 100 may wirelessly receive data from the electronic device 10. The first audio output apparatus 100 may receive a media packet by overhearing a data exchange between the electronic device 10 and the second audio output apparatus 200, instead of directly exchanging data with the electronic device 10.

For example, the first audio output apparatus 100 and the second audio output apparatus 200 may constitute a pair of wireless earphones performing Bluetooth® communication as slave devices of the electronic device 10. The second audio output apparatus 200 may be a primary device configured to exchange data with the electronic device 10, which is a master device, and the first audio output apparatus 100 may be a secondary device configured to overhear a data exchange between the electronic device 10 and the second audio output apparatus 200.

In step S710, the first audio output apparatus 100 receives a first media packet from the electronic device 10 through a first frequency channel. As described above with reference to FIGS. 4 and 5, each media packet may include an index.

In step S720, the first audio output apparatus 100 determines to maintain the first frequency channel based on the first media packet and a second media packet previously received.

When the first audio output apparatus 100 successfully receives a media packet from the electronic device 10, the first audio output apparatus 100 may identify index information of a sample of the corresponding media packet.

The first audio output apparatus 100 may determine whether a reception of at least one media packet has failed based on an index of the first media packet and an index of the second media packet. For example, when the index of the first media packet and the index of the second media packet are consecutive, the first audio output apparatus 100 may determine that there is no media packet that is not received from the electronic device 10 between the second media packet and the first media packet. However, when the index of the first media packet and the index of the second media packet are not consecutive, the first audio output apparatus 100 may determine that at least one media packet has not been received from the electronic device 10 between the second media packet and the first media packet.

Based on the determination that the reception of the at least one media packet has failed, the first audio output apparatus 100 may generate a stay packet including the index of the second media packet

In step S730, the first audio output apparatus 100 transmits, to the second audio output apparatus, a stay packet indicating to maintain the first frequency channel.

When the second audio output apparatus 200 receives the stay packet from the first audio output apparatus 100, the second audio output apparatus 200 may transmit, to the first audio output apparatus, data of a sample corresponding between an index included in the stay packet and an index of a packet most recently received. For example, the second audio output apparatus 200 may transmit, to the first audio output apparatus 100, a third media packet received between the second media packet corresponding to the index included in the stay packet and the first media packet recently received. The second audio output apparatus 200 receiving the stay packet may transmit the third media packet to the first audio output apparatus 100 through the first frequency channel, instead of performing a frequency channel hopping.

In step S740, the first audio output apparatus 100 receives the third media packet from the second audio output apparatus 200 through the first frequency channel in response to receiving the stay packet. The first audio output apparatus 100 may transmit a reception acknowledgement response (e.g., an ACK) regarding the third media packet to the second audio output apparatus 200.

The first audio output apparatus 100 may exchange data related to the third media packet, and then perform hopping to a predetermined frequency for communication with the electronic device 10.

For stable audio output, the first audio output apparatus 100 and the second audio output apparatus 200 should perform synchronization at least once within a critical time. For example, as in step S730, when the stay packet is transmitted within the critical time, an additional packet exchange for synchronization is not required. However, when the packet exchange for synchronization is not performed for the critical time, the first audio output apparatus 100 may transmit a synchronization request packet for performing synchronization to the second audio output apparatus 200.

The first audio output apparatus 100 may transmit a synchronization request packet to the second audio output apparatus 200 through a second frequency channel, where the synchronization request packet includes an index of a media packet most recently received.

When the second audio output apparatus receives the synchronization request packet from the first audio output apparatus 100, the second audio output apparatus 200 may determine whether to retransmit data to the first audio output apparatus 100 based on the synchronization request packet.

When an index included in the synchronization request packet and the index of the packet most recently received are consecutive, the second audio output apparatus 200 may determine that it is not necessary to retransmit the data to the first audio output apparatus 100. However, when the index included in the synchronization request packet and the index of the packet most recently received are not consecutive, the second audio output apparatus 200 may determine to retransmit the data to the first audio output apparatus 100.

The second audio output apparatus 200 may transmit a synchronization response packet to the first audio output apparatus 100, the synchronization response packet including information informing the determination result of whether to retransmit the data to the first audio output apparatus 100. When it is determined that the data retransmission is necessary, the second audio output apparatus 200 may maintain the second frequency channel instead of performing a frequency channel hopping.

For example, when the first audio output apparatus 100 receives the synchronization response packet from the second audio output apparatus 200 through the second frequency channel, the first audio output apparatus 100 may determine whether to maintain the second frequency channel based on the synchronization response packet.

When it is determined to maintain the second frequency channel, the first audio output apparatus 100 may receive a fourth media packet from the second audio output apparatus 200 through the second frequency channel. The first audio output apparatus 100 may transmit an ACK of the fourth media packet to the second audio output apparatus 200.

When it is determined that the data retransmission is not necessary based on the synchronization response packet, the first audio output apparatus 100 may perform a frequency channel hopping and wait for data to be received from the electronic device 100.

As another example, when the first audio output apparatus 100 does not receive the synchronization response packet from the second audio output apparatus 200 through the second frequency channel, the first audio output apparatus 100 may perform frequency hopping to a third frequency channel and retransmit a synchronization request packet to the second audio output apparatus through a third frequency channel. The first audio output apparatus 100 may receive the synchronization response packet from the second audio output apparatus 200 through the third frequency channel. The first audio output apparatus 100 may determine to maintain the third frequency channel based on the synchronization response packet, and receive a fourth media packet from the second audio output apparatus 200 through the third frequency channel. The first audio output apparatus 100 may transmit an ACK of the fourth media packet to the second audio output apparatus 200.

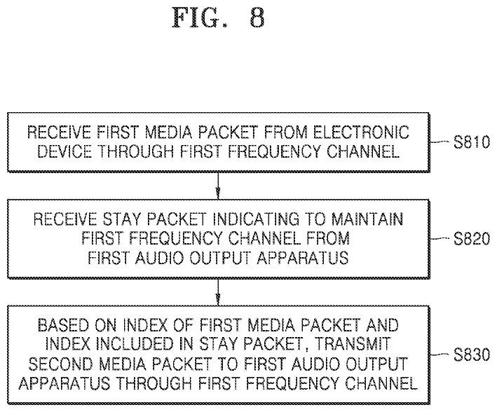

FIG. 8 is a flowchart illustrating a method performed by a second audio output apparatus, according to an embodiment.

Referring to FIG. 8, the second audio output apparatus 200 may form a pair with the first audio output apparatus 100 to receive data from the electronic device 10 and output an audio signal obtained from the received data. The second audio output apparatus 200 may wirelessly exchange data with the electronic device 10.

In step S810, the second audio output apparatus 200 receives the first media packet from the electronic device 10 through the first frequency channel. As described above with reference to FIGS. 4 and 5, each media packet may include an index.

The first audio output apparatus 100 may receive the first media packet by overhearing the data exchange between the electronic device 10 and the second audio output apparatus 200, instead of directly exchanging data with the electronic device 10. When it is determined that there is a media packet that has not been received based on the first media packet and a second media packet previously received, the first audio output apparatus 100 may determine to maintain the first frequency channel. When it is determined to maintain the first frequency channel, the first audio output apparatus 100 may transmit a stay packet to the second audio output apparatus 200, where the stay packet indicates to maintain the first frequency channel.

In step S820, the second audio output apparatus 200 receives the stay packet indicating to maintain the first frequency channel from the first audio output apparatus 100. The second audio output apparatus 200 may transmit, to the electronic device 10, an ACK signal informing that the first media packet is successfully received.

In step S830, the second audio output apparatus 200 transmits a second media packet to the first audio output apparatus 100 through the first frequency channel based on an index of the first media packet and an index included in the stay packet.

When the second audio output apparatus 200 receives the stay packet from the first audio output apparatus 100, the second audio output apparatus 200 may transmit, to the first audio output apparatus 100, data of a sample corresponding between the index included in the stay packet and an index of a packet most recently received.

The second audio output apparatus 200 may perform hopping to a predetermined frequency for communication with the electronic device 10, after finishing the data exchange related to the second media packet.

For stable audio output, the first audio output apparatus 100 and the second audio output apparatus 200 should perform synchronization at least once within a predetermined time. When a packet exchange for synchronization is not performed for the predetermined time, the second audio output apparatus 200 may receive a synchronization request packet for performing synchronization from the first audio output apparatus 100.

The second audio output apparatus 200 may receive a synchronization request packet from the first audio output apparatus 100 through a second frequency channel, the synchronization request packet including an index of a media packet that the first audio output apparatus 100 most recently received.

When the second audio output apparatus 200 receives the synchronization request packet from the first audio output apparatus 100, the second audio output apparatus may determine whether it is necessary to retransmit data to the first audio output apparatus 100 based on the synchronization request packet.

When an index included in the synchronization request packet and an index of a packet most recently received are consecutive, the second audio output apparatus 200 may determine that it is not necessary to retransmit the data to the first audio output apparatus 100. However, when the index included in the synchronization request packet and the index of the packet most recently transmitted are not consecutive, the second audio output apparatus 200 may determine that it is necessary to retransmit the data to the first audio output apparatus 100.

The second audio output apparatus 200 may transmit a synchronization response packet to the first audio output apparatus. The synchronization response packet informs of the determination result as to whether the data transmission is necessary. When it is determined that the data retransmission is necessary, the first audio output apparatus 100 and the second audio output apparatus 200 may maintain the second frequency channel instead of performing a frequency channel hopping. The second audio output apparatus 200 may retransmit the data to the first audio output apparatus 100 through the second frequency channel.

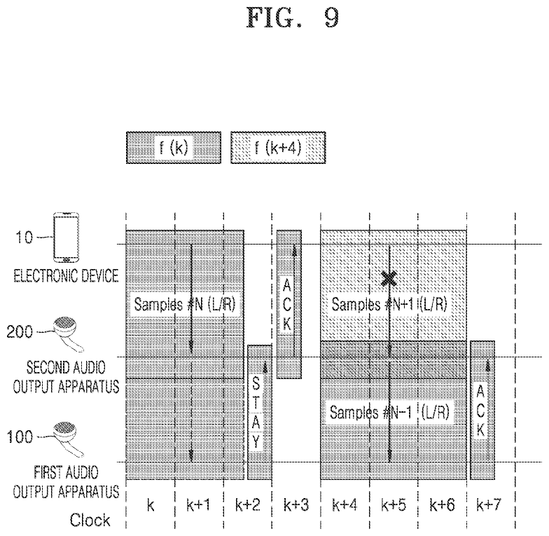

FIG. 9 illustrates a first audio output apparatus transmitting a stay packet to a second audio output apparatus, according to an embodiment.

Referring to FIG. 9, the second audio output apparatus 200 retransmits data to the first audio output apparatus 100 when the first audio output apparatus 100 fails to receive a sample #N−1. In a communication between the first audio output apparatus 100 and the second audio output apparatus 200, a Bluetooth® communication scheme may be used rather than BLE.

When the first audio output apparatus 100 receives a current packet from the electronic device 10 through a frequency channel f(k) during a time period from a time slot k to a time slot k+2, the first audio output apparatus 100 may identify index information of a sample #N included in the current packet. Because an index of a sample #N−2 included in a packet most recently received and an index of the sample #N included in the current sample are not consecutive, the first audio output apparatus 100 may determine that a reception failure has occurred.

The first audio output apparatus 100 may transmit a stay packet to the second audio output apparatus 200 in the time slot k+2. The stay packet may include a last sample index. The last sample index may refer to an index of a sample included in a packet, i.e., the last packet being received by the first audio output apparatus 100 from the second audio output apparatus 200 among packets received prior to the current packet. For example, the stay packet may include N−2 that is an index of a packet most recently received.

As illustrated in FIG. 9, it may be required that a first time point at which data transmission to the second audio output apparatus 200 from the electronic device 10 is ended and a second time point at which the first audio output apparatus 100 determines whether the reception has failed and transmits the stay packet should be included in the same time slot. That is, during the time slot k+2, the electronic device 10 should end the data transmission to the second audio output apparatus 200 and the first audio output apparatus 100 should transmit the stay packet. Thus, a length of data from the electronic device 10 to the second audio output apparatus 200 may be determined in advance so that the first audio output apparatus 100 may secure a sufficient processing time for transmitting the stay packet. For example, to secure a sufficient processing time for transmitting the stay packet for the first audio output apparatus 100, it may be determined that data transmitted from the electronic device 10 is short.

The second audio output apparatus 200 may receive the stay packet from the first audio output apparatus 100, and then transmit an ACK to the electronic device 10 in a next time slot. However, embodiments of the disclosure are not limited to the example illustrated in FIG. 9, and the second audio output apparatus 200 may receive the stay packet from the first audio output apparatus 100 in the same time slot as the time slot in which the second audio output apparatus 200 transmits an ACK to the electronic device 100.

Based on an index N−2 included in the stay packet and the index N of the current packet, the second audio output apparatus 200 may prepare for retransmission of the data that the first audio output apparatus 200 failed to receive. The second audio output apparatus 200 may prepare to transmit data of sample #N−1 corresponding between the index N−2 included in the stay packet and the index N of the current packet. The second audio output apparatus 200 receiving the stay packet may transmit the prepared sample to the first audio output apparatus 100 instead of performing hopping in a time slot k+4.

The first audio output apparatus 100 transmits the stay packet in the time slot k+2, and then does not perform hopping in the time slot k+4. The first audio output apparatus 100 does not perform hopping in the time slot k+4, and starts receiving the sample from the second audio output apparatus 200.

The first audio output apparatus 100 may succeed in receiving the sample #N−1 from the second audio output apparatus 200 through the frequency channel f(k) during a time period from the time slot k+4 to a time slot k+6. After receiving the sample #N−1 from the second audio output apparatus 200, the first audio output apparatus 100 does not perform a frequency channel hopping and may transmit an ACK to the second audio output apparatus 200 through the frequency channel f(k) in a time slot k+7.

During a time period from the time slot k+4 to the time slot k+7, the electronic device 10 performs hopping to the frequency channel f(k+4), but the first audio output apparatus 100 and the second audio output apparatus 200 maintain the frequency channel f(k). Thus, the first audio output apparatus 100 and the second audio output apparatus 200 may not receive a sample #N+1 from the electronic device 10 during the time period from the time slot k+4 to the time slot k+6.

After exchanging data in the time slot k+7, the first audio output apparatus 100 and the second audio output apparatus 200 may perform hopping to a predetermined frequency to communicate with the electronic device 10 in a time slot k+8.

When synchronization through a periodical packet exchange is necessary, the first audio output apparatus 100 and the second audio output apparatus 200 may be operated as described below.

When an index of a sample most recently received by the first audio output apparatus 100 and an index included in a sample included in the current packet are consecutive, no data exchange is required between the first audio output apparatus 100 and the second audio output apparatus 200. When indices of the received samples are consecutive, the first audio output apparatus 100 may determine that data reception is continuously successful.

When the first audio output apparatus 100 continuously succeeds in receiving data for a critical synchronization time (e.g., 100 ms), the first audio output apparatus 100 may transmit, to the second audio output apparatus 200, a stay packet including a predetermined value as a last sample index. When it is determined that the data reception is continuously successful, the first audio output apparatus 100 may inform that maintenance of the frequency channel is unnecessary by transmitting a stay message including 0xFFFF value as an index to the second audio output apparatus 200.

The first audio output apparatus 100 may terminate the connection when data is not received from the electronic device for a predetermined period of time.

When the first audio output apparatus 100 and the second audio output apparatus 200 output a stereo signal, the second audio output apparatus 200 may transmit, to the first audio output apparatus 100, only a part of data received from the electronic device 10. The second audio output apparatus 200 may obtain only data related to an audio channel output through the first audio output apparatus 100 from among stereo data including information on two or more audio channels received from the electronic device, and transmit the obtained data to the first audio output apparatus 100.

Thus, a size of data transmitted to the first audio output apparatus 100 from the second audio output apparatus 200 may be reduced, and the latency and power consumption until the second audio output apparatus 200 successfully receives the data may be reduced.

When the first audio output apparatus 100 outputs a right audio signal and the second audio output apparatus 200 outputs a left audio signal, the second audio output apparatus 200 may extract only the right audio signal from among the stereo data received from the electronic device 10 and transmit the extracted right audio signal to the first audio output apparatus 100.

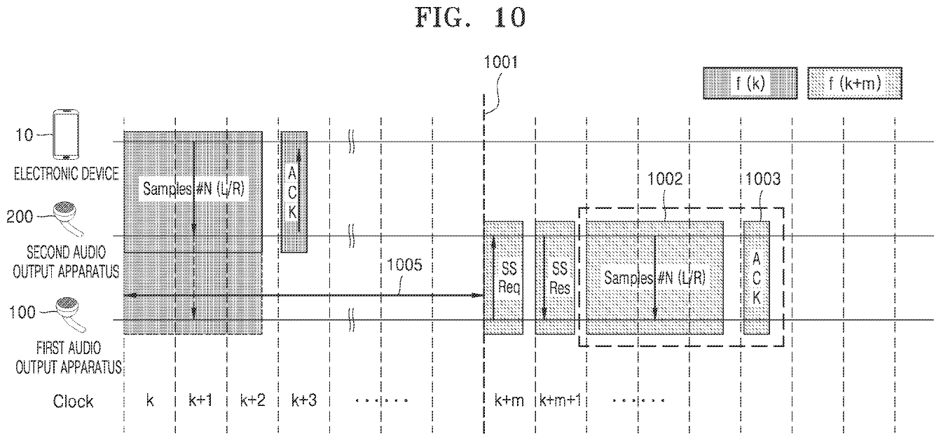

FIG. 10 illustrates a first audio output apparatus transmitting a synchronization packet to a second audio output apparatus, according to an embodiment.

For synchronization between the second audio output apparatus 200 and the first audio output apparatus 100, a data exchange should be performed at least once within a critical time. As described above with reference to FIG. 9, when the stay packet is exchanged within the critical time, an additional packet exchange is unnecessary. However, when the data exchange is not performed within the critical time, the first audio output apparatus 100 and the second audio output apparatus 200 may exchange synchronization packets to perform synchronization. For example, the synchronization packets exchanged between the first audio output apparatus 100 and the second audio output apparatus 200 may be referred to as a stay & sync (SS) request packet and a stay & sync (SS) response packet.

A time point 1001 of FIG. 10 is when a critical time 1005 expires. FIG. 10 illustrates a case in which data exchange for synchronization between the first audio output apparatus 100 and the second audio output apparatus 200 is not performed for the critical time 1005.

When a packet exchange for synchronization with the second audio output apparatus 200 does not occur within the critical time 1005, the first audio output apparatus 100 may transmit, to the second audio output apparatus 200, a sync request packet SS Req including a last sample index. The last sample index may refer to an index of a sample included in a packet most recently received by the first audio output apparatus 100 from the second audio output apparatus 200.

When the critical time 1005 expires, the first audio output apparatus 100 may transmit a sync request packet to the second audio output apparatus 200 through the frequency channel f(k+m) in a time slot k+m. The second audio output apparatus 200 may transmit a sync response packet through the same frequency channel f(k+m) in a next time slot k+m+1 by referring to a last sample index included in the sync request packet. The second audio output apparatus 200 may determine a parameter value indicating when a data transmission to the first audio output apparatus 100 is necessary, and when it is not, and transmit a sync response packet including the determined parameter value.

When it is determined that the data transmission to the first audio output apparatus 100 is necessary, the second audio output apparatus 200 may maintain the frequency channel f(k+m) without performing a frequency channel hopping. The second audio output apparatus 200 may transmit a sync response packet SS Res informing that it is necessary to transmit data, through the same frequency channel f(k+m) in a next time slot k+m+1. When it is determined based on the SS response packet SS Res that data exchange is necessary, the first audio output apparatus 100 may maintain the frequency channel f(k+m) instead of performing a frequency channel hopping.

When a data exchange is necessary, the first audio output apparatus 100 may receive a sample #N 1002 that was not received in the past, from the second audio output apparatus 200, through the frequency channel f(k+m) during a time period from the time slot k+m+2 to the time slot k+m+4. The first audio output apparatus 100 may transmit an ACK 1003 with respect to the sample #N to the second audio output apparatus 200.

However, when it is determined that a data transmission to the first audio output apparatus 100 is not necessary, the second audio output apparatus 200 may perform a frequency channel hopping and wait for data transmission by the electronic device 10.

The second audio output apparatus 200 may transmit an SS response packet SS Res informing that it is not necessary to transmit data, through the same frequency channel f(k+m) in the next time slot k+m+1. When it is determined, based on the SS response packet SS Res, that the data exchange is not necessary, the first audio output apparatus 100 may perform a frequency channel hopping and wait for data transmission by the electronic device 10. In this case, the packets 1002 and 1003 do not have to be retransmitted.

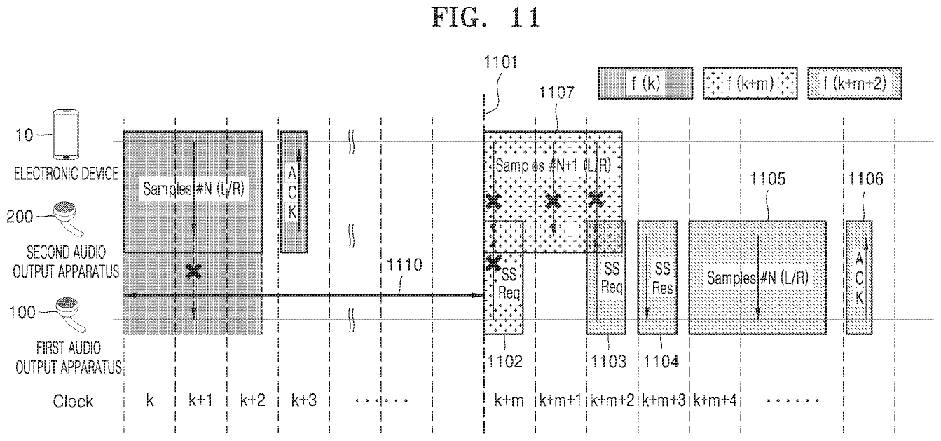

FIG. 11 illustrates a first audio output apparatus transmitting a synchronization packet to a second audio output apparatus, according to an embodiment.

Referring to FIG. 11, after the first audio output apparatus 100 fails to receive the sample #N, a data exchange is not performed between the first audio output apparatus 100 and the second audio output apparatus 200 during a critical time 1110. A time point 1101 is when the critical time 1110 expires.

When a packet exchange for synchronization with the second audio output apparatus 200 does not occur for the critical time 1110, the first audio output apparatus 100 may transmit a sync request packet 1102, which is an index of a packet most recently received successfully, to the second audio output apparatus 200.

When the sync request packet 1102 and data 1107 transmitted from the electronic device 10 collide with each other in the same time slot k+m, the SS Req fails to receive the data and perform a frequency channel hopping in the next time slot k+m+1.

Because the electronic device 10 is not aware of the collision, the electronic device 10 continuously transmits the data through the existing transmission frequency band, f(k+m), even during a time period from the time slot k+m+1 to the time slot k+m+2.

When a response to the sync request packet transmitted in the time slot k+m is not received in the next time slot k+m+1, the first audio output apparatus 100 may determine that the transmission of the sync request packet has failed. When it is determined that the transmission of the sync request packet has failed, the first audio output apparatus 100 may transmit the sync request packet again.

The first audio output apparatus 100 may retransmit the sync request packet 1103 through the frequency channel f(k+m+2) in the time slot k+m+2. When receiving the sync request packet 1103 and determining that a data transmission to the first audio output apparatus 100 is necessary based on the sync request packet 1103, the second audio output apparatus 200 may maintain the frequency channel f(k+m+2) rather than performing a frequency channel hopping.

In a next time slot k+m+3, the second audio output apparatus 200 may transmit a sync response packet 1104 informing that a data transmission through the same frequency channel f(k+m+2) is necessary.

When it is determined that the retransmission of the data is necessary based on the sync response packet 1104, the first audio output apparatus 100 may maintain the frequency channel f(k+m+2) instead of performing a frequency channel hopping.

When it is determined that the data retransmission is necessary, the first audio output apparatus 100 may receive a sample #N 1105 that was not received in the past from the second audio output apparatus, through the frequency channel f(k+m+2) during a time period from a time slot k+m+4 to a time slot k+m+6. The first audio output apparatus 100 may transmit an ACK 1106 for the sample #N 1105 to the second audio output apparatus 200.

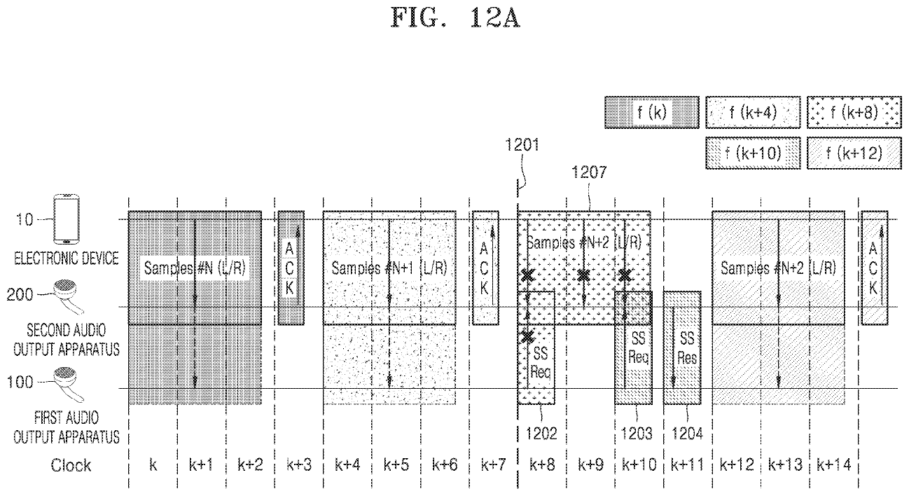

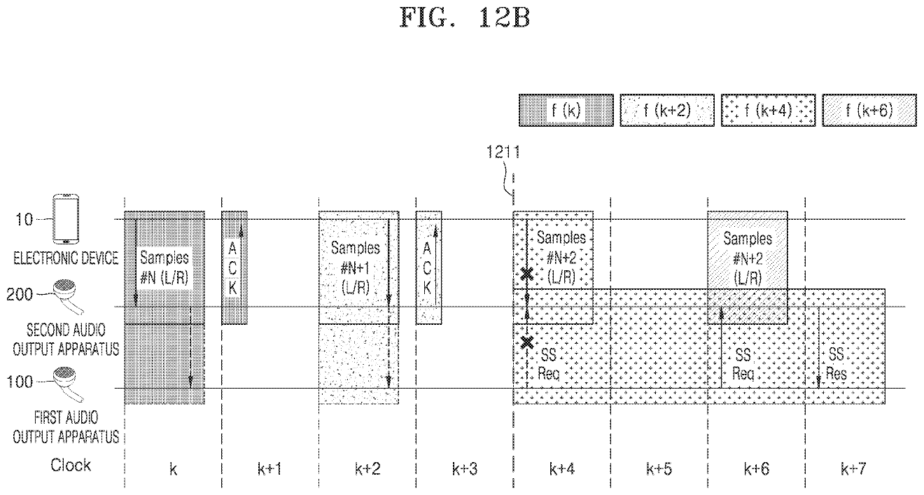

FIG. 12A illustrates a first audio output apparatus transmitting a synchronization packet to a second audio output apparatus, according to an embodiment.

Referring to FIG. 12A, the first audio output apparatus 100 continuously succeeds in receiving a packet for a critical time. A time point 1201 is when the critical time expires.

Even when the first audio output apparatus 100 succeeds in receiving a packet and no message is exchanged with the second audio output apparatus 200, when the critical time elapses, the first audio output apparatus 100 may attempt to exchange a synchronization packet.

In the time slot k+2, the first audio output apparatus 100 may transmit, to the second audio output apparatus 200, a synchronization request packet including N+1, which is an index of a packet most recently received successfully. Alternatively, the first audio output apparatus 100 may transmit, to the second audio output apparatus 200, a synchronization request packet including a predetermined value so as to indicate that a data reception is continuously successful. For example, when the first audio output apparatus 100 determines that the data reception is continuously successful, it may be predetermined to transmit, to the second audio output apparatus 200, a synchronization request packet including a 0xFFFF value as an index.

When a synchronization request message 1202 and data 1207 transmitted from the electronic device 10 collide with each other in a same time slot k+8, the second audio output apparatus 200 fails to receive the data, and performs a frequency channel hopping in a next time slot k+9.

Because the electronic device 10 is not aware of the collision, the electronic device 10 continuously transmit, from the time slot k+8 to a time slot k+10, the data through f(k+8), which is an existing transmission frequency band.

When a response to the synchronization request packet 1202 transmitted in the time slot k+8 is not received in a next time slot k+9, the first audio output apparatus 100 may transmit the synchronization request packet again.

The first audio output apparatus 100 may retransmit a synchronization request packet 1203 through a frequency channel f(k+10) in a time slot k+10. The second audio output apparatus 200 may determine that the data retransmission to the first audio output apparatus 100 is unnecessary based on the synchronization request packet 1203, and transmit a synchronization response packet 1204 informing the unnecessity of data transmission through the same frequency channel f(k+10) in a next time slot k+11.

The first audio output apparatus 100 may determine that the data retransmission is unnecessary based on the synchronization response packet 1204, and perform a frequency channel hopping.

Because an ACK is not received from the second audio output apparatus 200 in the time slot k+11, the electronic device 10 may perform frequency channel hopping in a next time slot k+12 and retransmit sample #N+2 through a frequency channel f(k+12). Both the first audio output apparatus 100 and the second audio output apparatus 200 may perform frequency channel hopping to thereby receive the sample #N+2 through the frequency channel f(k+12) during a time slot k+12 to a time slot k+14.

When the electronic device 10 transmits data by using a single time slot, a collision with a synchronization request packet transmitted from the first audio output apparatus 100 may occur.

FIG. 12B illustrates a first audio output apparatus transmitting a synchronization packet to a second audio output apparatus, according to an embodiment.

Referring to FIG. 12B, to prevent the problem described above, when a synchronization request packet is not received in a time slot in which the synchronization request packet is expected to be received based on a time point 1211 at which a critical time expires, the second audio output apparatus 200 may maintain the frequency channel rather than performing a frequency channel hopping. For example, when the synchronization request packet is not received in the time slot k+4 in which the synchronization request packet is expected to be received, the second audio output apparatus 200 may maintain the frequency channel f(k+4) rather than performing a frequency channel hopping. The first audio output apparatus 100 and the second audio output apparatus 200 may maintain the frequency channel f(k+4) from the time slot k+4 to a time slot k+7.

The first audio output apparatus 100 may attempt to retransmit the synchronization request packet up to a maximum number of times of retransmission through the maintained frequency channel, to thereby perform synchronization with the second audio output apparatus 200. When the retransmission of the synchronization request packet is attempted up to the maximum number of times of retransmission but no synchronization response packet is received, the first audio output apparatus 100 may terminate the Bluetooth connection.

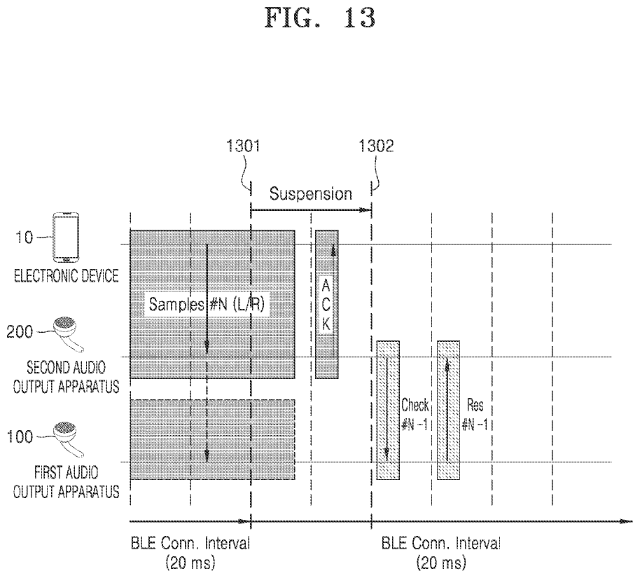

FIG. 13 illustrates a first audio output apparatus and a second audio output apparatus suspending a BLE transfer time, according to an embodiment.

Referring to FIG. 13, the first audio output apparatus 100 and the second audio output apparatus 200 may perform communication via BLE as well as Bluetooth®. While the electronic device 10 transmits data to the second audio output apparatus 200 and the first audio output apparatus 100 through a Bluetooth® channel, when the first audio output apparatus 100 and the second audio output apparatus 200 perform a channel transfer to BLE, the existing data reception from the electronic device 10 fails.

Thus, when both the second audio output apparatus 200 and the first audio output apparatus 100 are receiving data from the electronic device 10, the BLE transfer may be suspended until the second audio output apparatus 200 transmits an ACK to the electronic device 10.

An apparatus that is not capable of receiving the data among the second audio output apparatus 200 and the first audio output apparatus 100 may perform a BLE transfer. When a response is not received from the first audio output apparatus 100 until time out after the BLE transfer is performed, the second audio output apparatus 200 may perform a Bluetooth® transfer. When a data transmission from the second audio output apparatus 200 until time out after a BLE transfer is performed, the first audio output apparatus 100 may perform a Bluetooth® transfer.

As illustrated in FIG. 13, the BLE transfer time of the first audio output apparatus 200 and the first audio output apparatus 100 may be suspended from a first time point 1301 to a second time point 1302 in order to receive data from the electronic device 10. When the BLE transfer is performed, the first audio output apparatus 100 may exchange data Check #N−1 and Res #N−1 with the second audio output apparatus 200 through BLE to thereby check whether the second audio output apparatus 200 successfully receives the data.

In addition, if any one of the second audio output apparatus 200 or the first audio output apparatus 100 fails to receive the data through BLE, a time point at which the corresponding device performs a Bluetooth® transfer may be suspended by a transmission window expiration time.

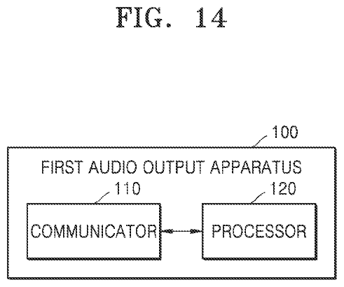

FIG. 14 illustrates a first audio output apparatus according to an embodiment.

Referring to FIG. 14, the first audio output apparatus 100 may be an audio output apparatus configured to output audio, and may include earphones, a headset, or a speaker. The first audio output apparatus 100 may communicate with other electronic devices and/or servers via a network by using a wired or wireless communication schemes.

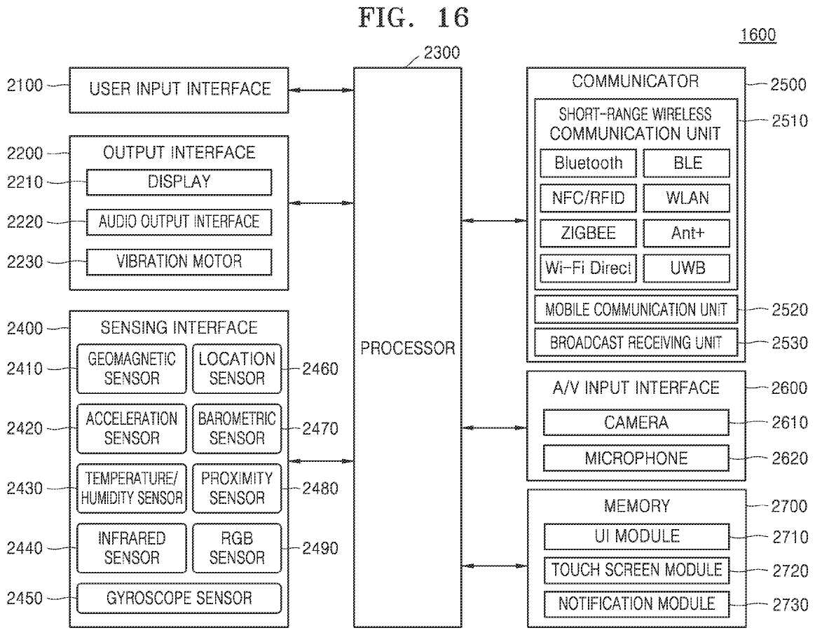

The first audio output apparatus 100 includes a communicator 110 and a processor 120. However, the first audio output apparatus 100 may be implemented by more elements than all of those illustrated in FIG. 14. For example, as illustrated in FIG. 16, the first audio output apparatus 100 may further include at least one of a user input interface 2100, an output interface 2200, a sensing interface 2400, an audio/video (AN) input interface 2600, or a memory 2700.

In FIG. 14, the first audio output apparatus 100 includes one processor 120, but the embodiments herein are not limited thereto. For example, the first audio output apparatus 100 may include a plurality of processors. At least some of the operations and functions of the processor 120 described below may be performed by the plurality of processors. The first audio output apparatus 100 may any of the methods described above with reference to FIGS. 1 to 13. Thus, the descriptions that are already provided above will be omitted.

The communicator 110 may perform wired or wireless communication with another device or network. To this end, the communicator 110 may include a communication module configured to support at least one of various wireless communication schemes. The communication module may be in the form of a chipset. The wireless communication may include at least one of cellular communication, Wi-Fi, Wi-Fi Direct, Bluetooth®, BLE, UWB, or near field communication (NFC).

The communicator 110 may be configured to wirelessly receive data from at least one of the electronic device 10 or the second audio output apparatus 200. For example, the communicator 110 may perform communication with at least one of the electronic device 10 or the second audio output apparatus 200 by using at least one of a Bluetooth® scheme or a BLE scheme.

The processor 120 may control the overall operations of the first audio output apparatus 100, and may include at least one processor, such as a central processing unit (CPU), a graphic processor unit (GPU), etc. The processor 120 may be configured to control other elements included in the first audio output apparatus 100 to receive data and output an audio signal.

For example, the description provided with reference to FIG. 7 may be applied to a specific method of controlling the first audio output apparatus 100 by using the processor 120, and redundant descriptions thereof will be omitted.

The processor 120 may control the communicator 110 to receive a first media packet transmitted from the electronic device 10 through a first frequency channel. Each media packet may include an index. When the media packet is successfully received from the electronic device 10, the processor 120 may identify index information of a sample of the corresponding media packet.

The processor 120 may determine whether to maintain the first frequency channel based on the first media packet and a second media packet received previously. The processor 120 may determine whether a reception of at least one media packet has failed, based on an index of the first media packet and an index of the second media packet.

For example, when the index of the first media packet and the index of the second media packet are consecutive, the processor 120 may determine that there is no media packet between the second media packet and the first media packet that is not received from the electronic device 10.

When it is determined a reception of the media packets has continuously been successful, the processor 120 may determine not to maintain the frequency channel. The processor 120 may perform a frequency channel hopping.

When the index of the first media packet and the index of the second media packet are not consecutive, the processor 120 may determine that a reception of at least one media packet transmitted from the electronic device 10 between the second media packet and the first media packet has failed.

Based on the determination of the failure of reception of the at least one media packet, the processor 120 may determine to maintain the frequency channel. The processor 120 may generate a stay packet including the index of the second media packet.

The processor 120 may control the communicator 110 to transmit, to the second audio output apparatus 200a, stay packet indicating to maintain the first frequency channel.

In response to the stay packet, the second audio output apparatus 200 may transmit a third media packet to the first audio output apparatus 100 through the first frequency channel without performing a frequency channel hopping.

The processor 120 may control the communicator 110 to receive the third media packet from the second audio output apparatus 200 through the first frequency channel. The processor 120 may control the communicator 110 to transmit an ACK for the third media packet to the second audio output apparatus 200.

After a data exchange associated with the third media packet is completed, the processor 120 may perform hopping to a predetermined frequency to communicate with the electronic device 10.

When a packet exchange is not performed for a critical time, the processor 120 may control the communicator 110 to transmit a synchronization request packet to the second audio output apparatus 200.

The processor 120 may transmit, to the second audio output apparatus 200 through a second frequency channel by using the communicator 110, a synchronization request packet including an index of a media packet most recently received.

The communicator 110 may receive, from the second audio output apparatus 200, a synchronization response packet including information informing a determination result regarding whether a retransmission of data is necessary.

When it is determined that the data retransmission by the second audio output apparatus is necessary, the processor 120 may maintain the second frequency channel rather than performing a frequency channel hopping.

When the synchronization response packet is received from the second audio output apparatus 200 through the second frequency channel, the processor 120 may determine whether to maintain the second frequency channel based on the synchronization response packet. When it is determined to maintain the second frequency channel, the processor 120 may receive a fourth media packet from the second audio output apparatus 200 through the second frequency channel. The processor 120 may transmit an ACK for the fourth media packet to the second audio output apparatus 200.

When it is determined that the data retransmission is unnecessary based on the synchronization response packet, the processor 120 may perform a frequency channel hopping and wait for data transmission from the electronic device 10.

In addition, when no synchronization response packet is received from the second audio output apparatus 200 through the second frequency channel during at least one time slot, the processor 120 may transmit a synchronization request packet again to the second audio output apparatus 200 through a third frequency channel. The processor 120 according to an embodiment may be configured to receive the synchronization response packet from the second audio output apparatus 200 through the third frequency channel, and determine whether to maintain the frequency channel.

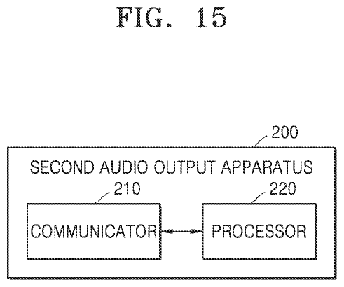

FIG. 15 illustrates a second audio output apparatus according to an embodiment.

Referring to FIG. 15, the second audio output apparatus 200 may be an audio output apparatus configured to output audio, and may include earphones, a headset, or a speaker. The second audio output apparatus 200 may communicate with other electronic devices and/or servers through a network by using a wired or wireless communication schemes.

The second audio output apparatus 200 includes a communicator 210 and a processor 220. However, the second audio output apparatus 200 may be implemented by more elements than all of those illustrated in FIG. 15. For example, as illustrated in FIG. 16, the second audio output apparatus 200 may further include at least one of a user input interface 2100, an output interface 2200, a sensing interface 2400, an A/V input interface 2600, or a memory 2700.

In FIG. 15, the second audio output apparatus 200 includes one processor 220, but the embodiments are not limited thereto. For example, the second audio output apparatus 200 may include a plurality of processors. At least some of the operations and functions of the processor 220 described below may be performed by the plurality of processors. The second audio output apparatus 200 may perform any of the methods described above with reference to FIGS. 1 to 13. Thus, descriptions that are already provided above will be omitted.

The communicator 210 may perform a wired or wireless communication with another device or network. To this end, the communicator 210 may include a communication module configured to support at least one of various wireless communication methods. For example, the communication module may be in the form a chipset. The wireless communication may include at least one of cellular communication, Wi-Fi, Wi-Fi Direct®, Bluetooth®, BLE, UWB, or NFC.

The communicator 210 may wirelessly receive data from at least one of the electronic device 10 or the second audio output apparatus 200. For example, the communicator 210 may perform communication with at least one of the electronic device 10 or the second audio output apparatus 200 by using a Bluetooth® scheme or a BLE scheme.

The processor 220 may control the overall operation of the second audio output apparatus 200, and may include at least one processor, such as a CPU, a GPU, etc. The processor 220 may control other elements included in the second audio output apparatus 200 in order to receive data and output an audio signal.

For example, the description provided with reference to FIG. 8 may be applied to a specific method of controlling the second audio output apparatus 200 by using the processor 220, and redundant descriptions thereof will be omitted.

The processor 220 may receive a first media packet transmitted from an electronic device, through a first frequency channel by using the communicator 210. Each media packet may include an index.

The processor 220 may receive a stay packet indicating to maintain the first frequency channel from the first audio output apparatus 100. The processor 220 may transmit, to the electronic device 10, an ACK informing that a reception of the first media packet has been successful.

Based on an index of the first media packet and an index of a stay packet, the processor 220 may retransmit a second media packet to the first audio output apparatus through the first frequency channel.

When the stay packet is received from the first audio output apparatus 100, the processor 220 may transmit, to the first audio output apparatus 100, data of a sample corresponding between the index included in the stay packet and an index of a packet received most recently.

After a data exchange associated with the second media packet is completed, the processor 220 may perform hopping to a predetermined frequency in order to communicate with the electronic device 10.

The first audio output apparatus 100 and the second audio output apparatus 200 should perform synchronization at least once within a predetermined time for stable audio output. When a packet exchange for synchronization is not performed for the predetermined time, the processor 220 may receive a synchronization request packet for performing synchronization from the first audio output apparatus 100 through the communicator 210. The synchronization request packet may include an index of a media packet most recently received by the first audio output apparatus 100.

When the synchronization request packet is received from the first audio output apparatus 100, the processor 220 may determine whether it is necessary to retransmit the data to the first audio output apparatus 100 based on the synchronization request packet.

When the index included in the synchronization request packet and the index of the packet most recently received are consecutive, the processor 220 may determine that the data retransmission is unnecessary. However, when the index included in the synchronization request packet and the index of the packet most recently transmitted are not consecutive, the processor 220 may determine that the data retransmission is necessary.

The processor 220 may transmit, to the first audio output apparatus 100, a synchronization response packet including informing the determination result regarding whether the data retransmission is necessary, by using the communicator 210. When it is determined that the data retransmission is necessary, the first audio output apparatus 100 and the second audio output apparatus 200 may maintain the second frequency channel instead of performing a frequency channel hopping. The processor 220 may control the communicator 210 to retransmit data to the first audio output apparatus 100 through the second frequency channel.

FIG. 16 illustrates an electronic device according to an embodiment.

Referring to FIG. 16, the electronic device 1600 may perform communication with at least one of the first audio output apparatus 100 or the second audio output apparatus 200. The electronic device 1600 may correspond to the electronic device 10 as described above with reference to FIGS. 1 to 15. The electronic device 1600 may be operated as a master device that is configured to transmit data to the first audio output apparatus 100 and the second audio output apparatus 200.

The electronic device 1600 includes a user input interface 2100, an output interface 2200, a processor 2300, a sensing interface 2400, a communicator 2500, an A/V input interface 2600, and a memory 2700.

The user input interface 2100 is for inputting, by a user, data for controlling the electronic device 1600. Examples of the user input interface 2100 may include, but are not limited to, a keypad, a dome switch, a touch pad (a capacitive overlay type, a resistive overlay type, an infrared beam type, a surface acoustic wave type, an integral strain gauge type, a piezoelectric type, etc.), a jog wheel, and a jog switch. The user input interface 2100 may be configured to receive a user input for connection to the first audio output apparatus 100 or the second audio output apparatus 200 and/or data communication.

The output interface 2200 may be configured to output an audio signal, a video signal, or a vibration signal, and may include a display 2210, an audio output interface 2220, and a vibration motor 2230. The vibration motor 1230 may output a vibration signal. For example, the vibration motor 1230 may output a vibration signal corresponding to an output of audio data or video data (e.g., a call signal reception sound, a message reception sound, etc.).

The sensing interface 2400 may detect a state of the electronic device 1600 and a state around the electronic device 1600, and transfer the detected information to the processor 2300.

The sensing interface 2400 includes a magnetic sensor 2410, an acceleration sensor 2420, a temperature/humidity sensor 2430, an infrared sensor 2440, a gyroscope sensor 2450, a location sensor (e.g., a global positioning system (GPS)) 2460, a barometric sensor 2470, a proximity sensor 2480, and an RGB sensor (illuminance sensor) 2490, but is not limited thereto. Functions of the above-described sensors may be inferred intuitively by those of ordinary skill in the art, and thus, detailed descriptions thereof will be omitted.

The communicator 2500 may include components for performing communication with another device. For example, the communicator 2500 includes a short-range wireless communication unit 2510, a mobile communication unit 2520, and a broadcast receiving unit 2530.

The short-range wireless communication unit 2510 may include a Bluetooth® communication unit, a BLE communication unit, a NFC unit, a WLAN (Wi-Fi) communication unit, a Zigbee® communication unit, an infrared data association (IrDA) communication unit, a Wi-Fi Direct® communication unit, a UWB communication unit, an Ant+ communication unit, but is not limited thereto. The communicator 2500 may communicate with the first audio output apparatus 100 and the second audio output apparatus 200 by using the Bluetooth® communication unit or the BLE communication unit.

The mobile communication unit 2520 is configured to transmit or receive a wireless signal to or from at least one of a base station, an external UE, or a server on a mobile communication network. In this case, the wireless signal may include a voice call signal, a video call signal, or data in any one of various formats according to transmission and reception of a text/multimedia message.

The broadcast receiving unit 2530 is configured to receive broadcast signals and/or broadcast-related information from the outside via a broadcast channel. The broadcast channel may include a satellite channel and a terrestrial channel. Alternatively, the electronic device 1600 may not include the broadcast receiving unit 2530.

The A/V input interface 2600 is for receiving an audio signal or a video signal, and includes a camera 2610, a microphone 2620, etc. The camera 2610 may be configured to obtain an image frame such as a still or moving image via an image sensor in a video call mode or capture mode. An image captured via the image sensor may be processed by the processor 2300 or a separate image processor.

An image frame obtained by the camera 2610 may be stored in the memory 2700 or may be transmitted to the outside via the communicator 2500. The camera 2610 may include two or more cameras depending on a configuration of a terminal.

The microphone 2620 is configured to receive an external sound signal and process the sound signal as electrical voice data. For example, the microphone 2620 may be configured to receive a sound signal from an external device or a speaker. The microphone 2620 may use various noise removal algorithms to remove noise generated in the process of receiving an external sound signal.

The memory 2700 may store programs necessary for processing or control operations performed by the processor 2300 or store data input to or output from the electronic device 1600.

The memory 2700 may include at least one type of storage medium, e.g., at least one of a flash memory-type memory, a hard disk-type memory, a multimedia card micro-type memory, a card-type memory (e.g., a secure digital (SD) card or an extreme digital (XD) memory), a random access memory (RAM), a static RAM (SRAM), a read-only memory (ROM), an electrically erasable programmable ROM (EEPROM), a PROM, a magnetic memory, a magnetic disc, or an optical disc.

Programs stored on the memory 2700 may be divided into a plurality of modules according to functions thereof, and for example, may be provided into a user interface (UI) module 2710, a touch screen module 2720, and a notification module 2730.

The UI module 2710 may provide a UI, a graphical user interface (GUI), etc., which is interlocked with the electronic device 1600 for each application. The touch screen module 2720 may be configured to detect a user's touch gesture on a touch screen and transmit, to the processor 2300, information about the detected touch gesture. The touch screen module 2720 may recognize and analyze a touch code. The touch screen module 2720 may be formed by separate hardware components including a controller.

The notification module 2730 may generate a signal for informing an event occurrence of the electronic device 1600. Examples of events occurring in the electronic device 1600 include call signal reception, message reception, key signal input, and schedule notification.

Embodiments of the disclosure may be implemented with a software program including instructions stored in a computer-readable storage medium.

A computer refers to a device configured to retrieve an instruction stored in a computer-readable storage medium and to operate, in response to the retrieved instruction, and may include an audio transmission apparatus and an audio reception apparatus according to embodiments of the disclosure.

The computer-readable storage medium may be provided as a non-transitory storage medium. In this regard, the term “non-transitory” only means that the storage medium does not include a signal and is a tangible device, and the term does not differentiate between where data is semi-permanently stored in the storage medium and where the data is temporarily stored in the storage medium.

Further, electronic apparatuses and methods according to the embodiments of the disclosure may be provided in the form of a computer program product. The computer program product may be traded, as a product, between a seller and a buyer.

The computer program product may include a software (S/W) program and a computer-readable storage medium having stored thereon the S/W program. For example, the computer program product may include a product (e.g. a downloadable application) in the form of an S/W program electronically distributed by a manufacturer of the electronic device or through an electronic market (e.g., Google Play Store™ and App Store™). For such electronic distribution, at least a part of the S/W program may be stored on the storage medium or may be temporarily generated. In this case, the storage medium may be a storage medium of a server of the manufacturer, a server of the electronic market, or a relay server for temporarily storing the S/W program.

In a system including a server and a UE (e.g., an electronic device and an audio output apparatus), the computer program product may include a storage medium of the server or a storage medium of the UE. Alternatively, when there is a third device (e.g., a smart phone) communicatively connected to the server or the UE, the computer program product may include a storage medium of the third device. Alternatively, the computer program product may include an S/W program itself that is transmitted from the server to the UE or the third device or that is transmitted from the third device to the UE.

In this case, one of the server, the UE, and the third device may execute the computer program product to perform methods according to the embodiments of the disclosure. Alternatively, at least two of the server, the UE, and the third device may execute the computer program product to perform the methods according to the embodiments of the disclosure in a distributed manner.

For example, the server (e.g., a cloud server, an artificial intelligence (AI) server, etc.) may execute the computer program product stored in the server to control the UE communicatively connected to the server to perform the methods according to embodiments of the disclosure.

As another example, the third device may execute the computer program product to control the UE communicatively connected to the third device to perform the methods according to the embodiments of the disclosure. In a specific example, the third device may remotely control the video transmitting or receiving apparatus to transmit or receive a packaged image.

When the third device executes the computer program product, the third device may download the computer program product from the server, and may execute the downloaded computer program product. Alternatively, the third device may execute the computer program product that is pre-loaded therein, and may perform the methods according to the embodiments of the disclosure.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a first audio output apparatus, the method comprising:
receiving a first media packet transmitted from an electronic device through a first frequency channel;
determining to maintain the first frequency channel, based on the first media packet and a second media packet received before the first media packet;
transmitting, to a second audio output apparatus, a stay packet indicating to maintain the first frequency channel; and
receiving a third media packet from the second audio output apparatus through the first frequency channel.

2. The method of claim 1, further comprising overhearing a data exchange between the electronic device and the second audio output apparatus.

3. The method of claim 1, wherein determining to maintain the first frequency channel comprises:
determining whether a reception of at least one media packet has failed, based on a first index of the first media packet and a second index of the second media packet; and
based on determining that the reception of the at least one media packet has failed, generating the stay packet including the second index of the second media packet.

4. The method of claim 1, wherein the first audio output apparatus and the second audio output apparatus form a pair of wireless earphones,
wherein the second audio output apparatus includes a primary device configured to perform a data exchange with the electronic device, and
wherein the first audio output apparatus includes a secondary device configured to overhear a data exchange between the electronic device and the second audio output apparatus.

5. The method of claim 1, further comprising transmitting, to the second audio output apparatus, a synchronization request packet for performing synchronization.

6. The method of claim 1, further comprising:
transmitting, to the second audio output apparatus, through a second frequency channel, a synchronization request packet including an index of a media packet recently received;
receiving a synchronization response packet from the second audio output apparatus through the second frequency channel;
determining to maintain the second frequency channel, based on the synchronization response packet;
receiving a fourth media packet from the second audio output apparatus through the second frequency channel; and
transmitting, to the second audio output apparatus, a reception acknowledgement response regarding the fourth media packet.

7. The method of claim 1, further comprising:
transmitting, to the second audio output apparatus, through a second frequency channel, a synchronization request packet including an index of a media packet recently received;
when a synchronization response packet is not received from the second audio output apparatus through the second frequency channel, transmitting the synchronization request packet to the second audio output apparatus through a third frequency channel;
receiving a synchronization response packet from the second audio output apparatus through the third frequency channel;
determining to maintain the third frequency channel based on the synchronization response packet;
receiving a fourth media packet from the second audio output apparatus through the third frequency channel; and
transmitting, to the second audio output apparatus, a reception acknowledgement response regarding the fourth media packet.

8. The method of claim 1, wherein the electronic device, the first audio output apparatus, and the second audio output apparatus perform communication by using a Bluetooth® communication scheme.

9. The method of claim 1, further comprising transmitting, to the second audio output apparatus, a reception acknowledgement response regarding the third media packet.

10. A method performed by a second audio output apparatus, the method comprising:
receiving a first media packet transmitted from an electronic device through a first frequency channel;
receiving, from a first audio output apparatus, a stay packet indicating to maintain the first frequency channel; and
based on a first index of the first media packet and a second index included in the stay packet, transmitting a second media packet to the first audio output apparatus through the first frequency channel.

11. A first audio output apparatus, the first audio output apparatus comprising:
a communicator configured to receive a media packet from an electronic device; and
a processor configured to:
receive a first media packet transmitted from the electronic device through a first frequency channel,
determine to maintain the first frequency channel, based on the first media packet and a second media packet received before the first media packet,
transmit, to a second audio output apparatus, a stay packet indicating to maintain the first frequency channel, and
receive a third media packet from the second audio output apparatus through the first audio output apparatus.

12. The first audio output apparatus of claim 11, wherein the communicator is further configured to receive the media packet by overhearing a data exchange between the electronic device and the second audio output apparatus.

13. The first audio output apparatus of claim 11, wherein the processor is further configured to:
based on a first index of the first media packet and a second index of the second media packet, determine whether a reception of at least one media packet has failed; and
based on determining that the reception of the at least one media packet has failed, generate the stay packet including the second index of the second media packet.

14. The first audio output apparatus of claim 11, wherein the first audio output apparatus and the second audio output apparatus form a pair of wireless earphones,
wherein the second audio output apparatus includes a primary device configured to perform a data exchange with the electronic device, and
wherein the first audio output apparatus includes a secondary device configured to overhear a data exchange between the electronic device and the second audio output apparatus.

15. The first audio output apparatus of claim 11, wherein the processor is further configured to control the communicator to transmit, to the second audio output apparatus, a synchronization request packet for performing synchronization.

16. The first audio output apparatus of claim 11, wherein the processor is further configured to:
transmit, to the second audio output apparatus, through a second frequency channel, a synchronization request packet including an index of a media packet recently received;
receive a synchronization response packet from the second audio output apparatus through the second frequency channel;
determine to maintain the second frequency channel based on the synchronization response packet;
receive a fourth media packet from the second audio output apparatus through the second frequency channel; and
transmit, to the second audio output apparatus, a reception acknowledgement response regarding the fourth media packet.

17. The first audio output apparatus of claim 11, wherein the processor is further configured to:
transmit, to the second audio output apparatus, through a second frequency channel, a synchronization request packet including an index of a media packet recently received;
when a synchronization response packet is not received from the second audio output apparatus through the second frequency channel, transmit the synchronization request packet to the second audio output apparatus through a third frequency channel;
receive the synchronization response packet from the second audio output apparatus through the third frequency channel;
determine to maintain the third frequency channel based on the synchronization response packet;
receive a fourth media packet from the second audio output apparatus through the third frequency channel; and
transmit, to the second audio output apparatus, a reception acknowledgement response regarding the fourth media packet.

18. The first audio output apparatus of claim 11, wherein the communicator is further configured to perform communication by using a Bluetooth® communication scheme.

19. The first audio output apparatus of claim 11, wherein the processor is further configured to transmit, to the second audio output apparatus, a reception acknowledgement response regarding the third media packet.
